(19) United States
(12) Patent Application Publication
(10) Pub. No.: US 2026/0169627 A1
(43) Pub. Date: Jun. 18, 2026

(54) SYMMETRIC I/O PORTS

(71) Applicant: Rambus Inc., San Jose, CA (US)

(72) Inventors: Evan Lawrence ERICKSON, Chapel Hill, NC (US); Robert E. PALMER, Chapel Hill, NC (US)

(21) Appl. No.: 19/411,701

(22) Filed: Dec. 8, 2025

Related U.S. Application Data
(60) Provisional application No. 63/733,061, filed on Dec. 12, 2024.
(60) Provisional application No. 63/800,628, filed on May 6, 2025.

(51) Int. Cl. G06F 3/06

(52) U.S. Cl. CPC G06F 3/061; G06F 3/0655; G06F 3/0673

(57) ABSTRACT

Multiple multi-channel dynamic random access memory (DRAM) die are stacked with each other. Each DRAM die of the stack includes two sets of I/O pads for each channel on the die. Based on the rotational orientation of a respective die in the stack, one of the two sets of I/O pads are used for data communication, and the other set is not used. The set of I/O pads that will be closest to the memory controller may be selected thereby shortening the signal traces between the controller and the die. The die in the stack may have one of two rotational orientations. A first one of the two sets of I/O pads are used by the die having a first rotational orientation (e.g., 0°), and a second one of the two sets of I/O pads are used by the die having a second rotational orientation (e.g., 180°).

### BRIEF DESCRIPTION OF THE DRAWINGS

FIGS. 1A-1E are views illustrating an example assembly with a symmetric input/output (I/O) pad arrangement.

FIG. 2 is a block diagram illustrating an example stacked die memory system.

FIG. 3 is a block diagram illustrating an example symmetric I/O memory system.

FIG. 4 is a block diagram illustrating a first example memory device.

FIG. 5 is a block diagram illustrating a second example memory device.

FIG. 6 is a flowchart illustrating a method of operating a memory component.

FIG. 7 is a flowchart illustrating a method of configuring a memory component.

FIG. 8 is a flowchart illustrating a method of operating a stacked die memory system.

FIG. 9 is a flowchart illustrating a method of configuring the data communication of a stacked die memory component.

FIG. 10 is a flowchart illustrating a method of configuring multiple multi-channel die in a stacked die memory system.

FIG. 11 is a block diagram illustrating a processing system.

### DETAILED DESCRIPTION OF THE EMBODIMENTS

In an embodiment, multiple multi-channel dynamic random access memory (DRAM) die are stacked with each other. Each DRAM die of the stack includes two sets of I/O pads for each channel on the die. Based on the rotational orientation of a respective die in the stack, one of the two sets of I/O pads are used for data communication, and the other set is not used and/or left unconnected. Thus, for example, the set of I/O pads that will be closest to the memory controller may be selected thereby shortening the signal traces between the controller and the die. In an embodiment, the die in the stack have one of two rotational orientations (e.g., 0° and 180°). A first one of the two sets of I/O pads are used by the die having a first rotational orientation (e.g., 0°) and a second one of the two sets of I/O pads are used by the die having a second rotational orientation (e.g., 180°).

The descriptions and embodiments disclosed herein are made primarily with references to DRAM devices and DRAM memory arrays. This, however, should be understood to be a first example due at least to the widespread adoption of DRAM technology. It should be understood that other memory technologies may also benefit from the methods and/or apparatus described herein. These memory technologies include, but are not limited to static random access memory (SRAM), non-volatile memory (such as flash), conductive bridging random access memory (CBRAM—a.k.a., programmable metallization cell—PMC), resistive random access memory (a.k.a., RRAM or ReRAM), magnetoresistive random-access memory (MRAM), Spin-Torque Transfer (STT-MRAM), phase change memory (PCM), and the like, and/or combinations thereof. Accordingly, it should be understood that in the disclosures and/or descriptions given herein, these aforementioned technologies may be substituted for, included with, and/or encompassed within, the references to DRAM, DRAM devices, and/or DRAM arrays made herein.

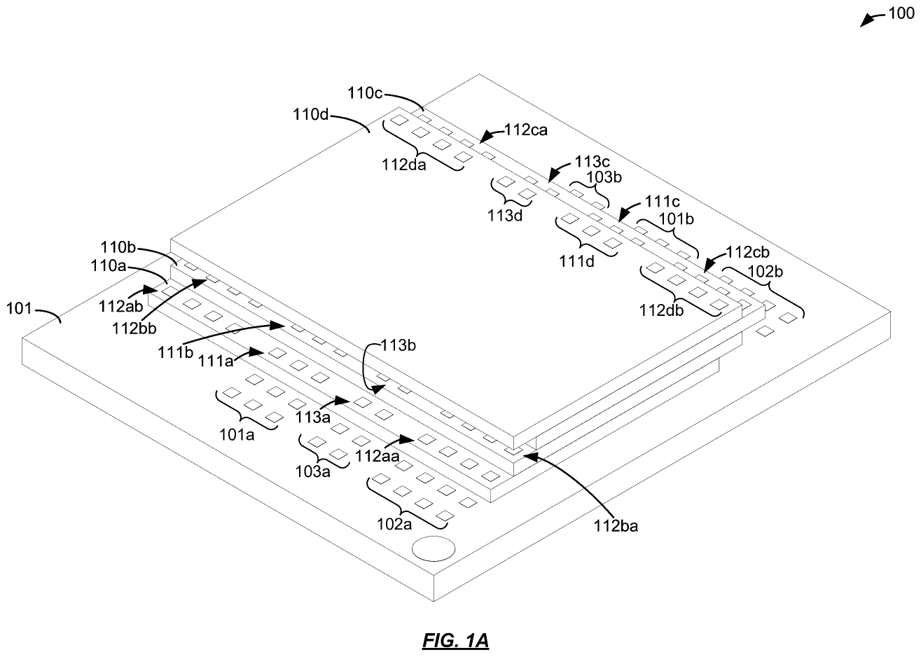

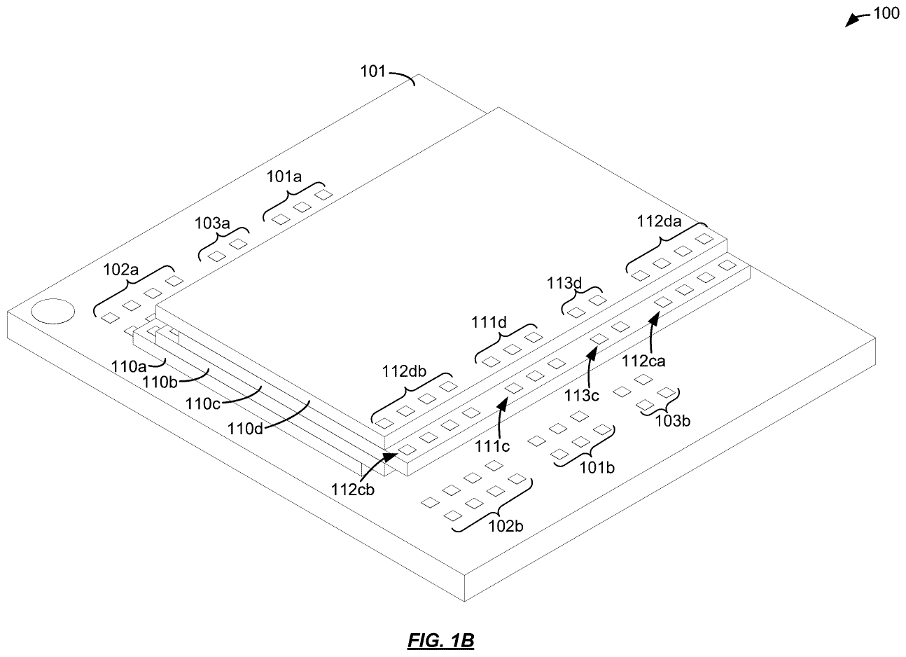

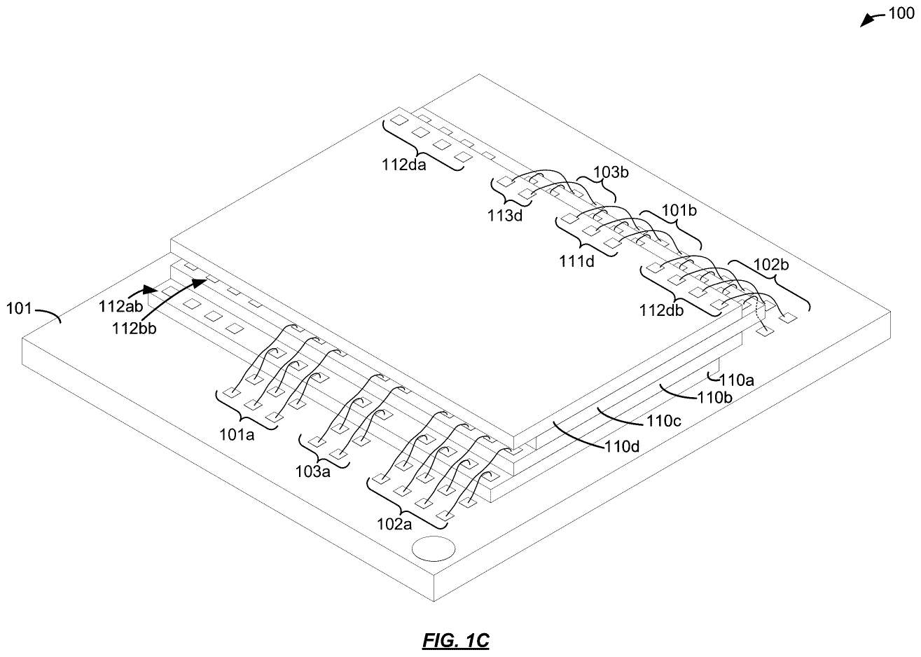

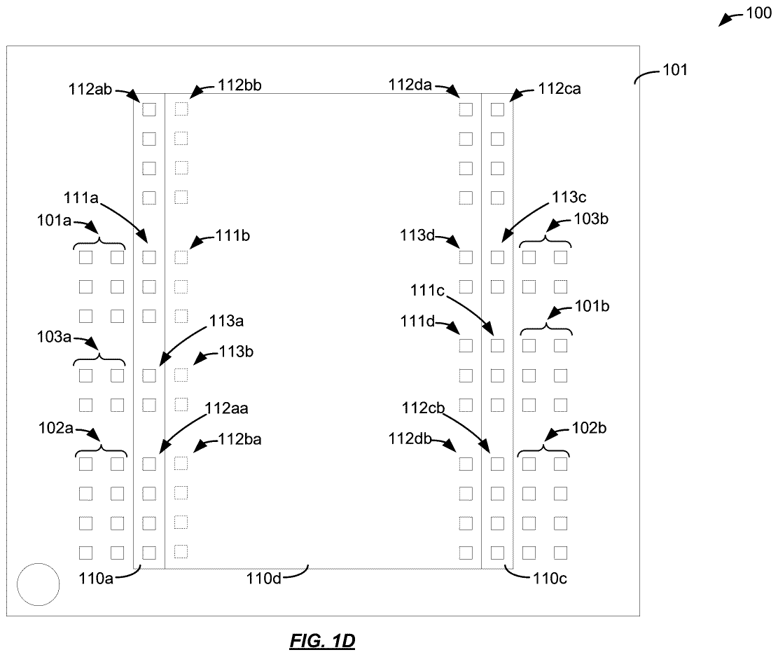

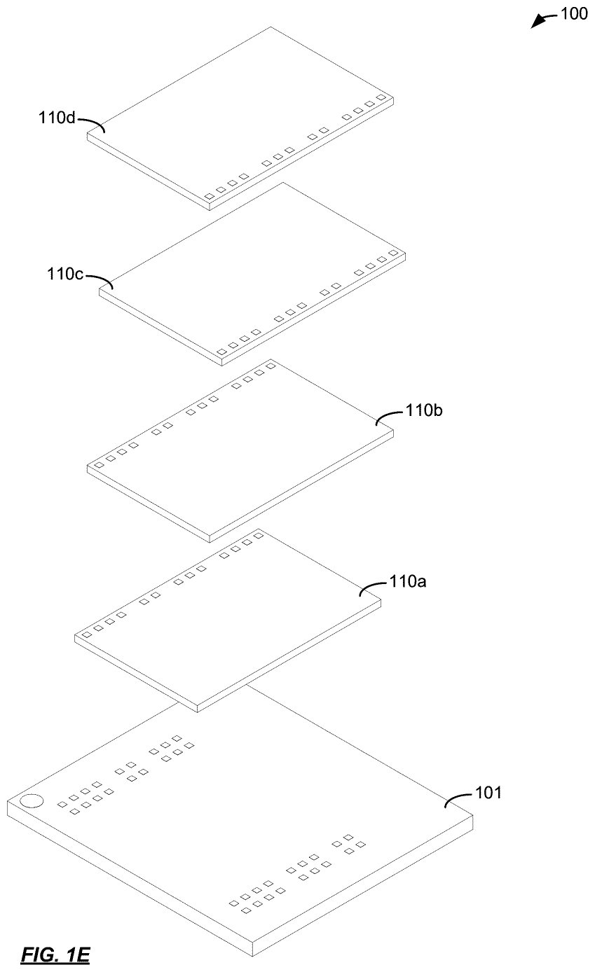

FIGS. 1A-1E are views illustrating an example assembly with a symmetric input/output (I/O) pad arrangement. FIGS. 1A-1B and FIGS. 1D-1E illustrate memory component 100 without, for the purposes of visual clarity, wire bond interconnections that should be understood to be present (as illustrated in FIG. 1C). FIG. 1A is a first isometric view of memory component 100. FIG. 1B is a second isometric view of memory component 100. FIG. 1C is the first isometric view of memory component 100 with example wire bonds illustrated. FIG. 1D is a top view of memory component 100 (with hidden bonding pads illustrated with dashed lines). FIG. 1E is an isometric and exploded view of memory component 100.

In FIGS. 1A-1B and FIGS. 1D-1E, memory component 100 comprises substrate 101 and memory die 110a-110d. Memory die 110a-110d, in an embodiment, have identical circuit designs and/or integrated circuit layouts (thus only differing from one or more of the other memory die 110a-110d, in some embodiments by, for example, programmed configuration memory and/or fuses). Substrate 101 includes command/address (CA) interface bonding pads 101a-101b, data (DQ) input/output (I/O) bonding pads 102a-102b, and additional interface bonding pads 103a-103b. Bonding pads 101a-103a are illustrated as being disposed generally near and along a first edge of substrate 101. Bonding pads 101b-103b are illustrated as being disposed generally near and along a second edge of substrate 101 that is opposite the first edge of substrate 101.

Memory die 110a includes CA interface bonding pads 11a, first DQ interface bonding pads 112aa, second DQ interface bonding pads 112ab, and additional interface bonding pads 113a. Memory die 110a is illustrated in FIGS. 1A-1E with a rotational orientation that places bonding pads 11a, 112aa-112ab, and 113a generally near the first edge of substrate 101 and bonding pads 101a-103a of substrate 101. Memory die 110b includes CA interface bonding pads 111b, first DQ interface bonding pads 112ba, second DQ interface bonding pads 112bb, and additional interface bonding pads 113b. Memory die 110b is illustrated in FIGS. 1A-1E with a rotational orientation that places bonding pads 111b, 112ba-112bb, and 113b generally near the first edge of substrate 101 and bonding pads 101a-103a of substrate 101.

Memory die 110c includes CA interface bonding pads 111c, first DQ interface bonding pads 112ca, second DQ interface bonding pads 112cb, and signal interface bonding pads 113c. Memory die 110c is illustrated in FIGS. 1A-1E with a rotational orientation that places bonding pads 111c, 112ca-112cb, and 113c generally near the second edge of substrate 101 and bonding pads 101b-103b of substrate 101. Memory die 110d includes CA interface bonding pads 111d, first DQ interface bonding pads 112da, second DQ interface bonding pads 112db, and additional interface bonding pads 113d. Memory die 110d is illustrated in FIGS. 1A-1E with a rotational orientation that places bonding pads 111d, 112da-112db, and 113d generally near the second edge of substrate 101 and bonding pads 101b-103b of substrate 101.

In FIGS. 1A-1E, memory die 110a is disposed on top of substrate 101, is stacked with memory die 110b-110d, and is rotationally oriented, in a manner that exposes at least one row of bonding pads along the near, in FIG. 1A, edge of memory die 110a (i.e., lower-left edge of memory die 110a in FIG. 1A and FIG. 1C, and upper-left edge of memory die 110a in FIG. 1B). The bonding pads of memory die 110a are exposed in a manner that allows for the connection, using wire bonds, with corresponding bonding pads of substrate 101. For example, as further illustrated by the wire bonds shown by FIG. 1C, bonding pads 111a may be wire bond connected to corresponding bonding pads 101a of substrate 101; bonding pads 112aa may be wire bond connected to corresponding bonding pads 102a of substrate 101; and bonding pads 113a may be wire bond connected to corresponding bonding pads 103a of substrate 101.

Similarly, memory die 110b is disposed on top of memory die 110a, is stacked with memory die 110a, 110c-110d, and is rotationally oriented, in a manner that exposes at least one row of bonding pads along the near, in FIG. 1A, edge of memory die 110b (i.e., lower-left edge of memory die 110b in FIG. 1A and FIG. 1C, and upper-left edge of memory die 110b in FIG. 1B). The bonding pads of memory die 110b are exposed in a manner that allows for the connection, using wire bonds, with corresponding bonding pads of substrate 101. For example, as illustrated in FIG. 1C, bonding pads 111b may be wire bond connected to corresponding bonding pads 101a of substrate 101; bonding pads 112ba may be wire bond connected to corresponding bonding pads 102a of substrate 101; and bonding pads 113b may be wire bond connected to corresponding bonding pads 103a of substrate 101.

Memory die 110c is disposed on top of memory die 110b, is stacked with memory die 110a-110b, 110d, and is rotationally oriented, in a manner that exposes at least one row of bonding pads along a far, in FIG. 1A, edge of memory die 110c (e.g., upper-right edge of memory die 110c in FIG. 1A and FIG. 1C, and lower-right edge of memory die 110c in FIG. 1B). The bonding pads of memory die 110c are exposed in a manner that allows for the connection, using wire bonds, with corresponding bonding pads of substrate 101. For example, as illustrated in FIG. 1C, bonding pads 111c may be wire bond connected to corresponding bonding pads 101b of substrate 101; bonding pads 112cb may be wire bond connected to corresponding bonding pads 102b of substrate 101; and bonding pads 113b may be wire bond connected to corresponding bonding pads 103b of substrate 101.

Memory die 110d is disposed on top of memory die 110c, is stacked with memory die 110a-110c, and is rotationally oriented, in a manner that exposes at least one row of bonding pads along a far, in FIG. 1A, edge of memory die 110d (e.g., upper-right edge of memory die 110d in FIG. 1A and FIG. 1C, and lower-right edge of memory die 110d in FIG. 1B). The bonding pads of memory die 110d are exposed in a manner that allows for the connection, using wire bonds, with corresponding bonding pads of substrate 101. For example, as illustrated in FIG. 1C, bonding pads 111d may be wire bond connected to corresponding bonding pads 101b of substrate 101; bonding pads 112db may be wire bond connected to corresponding bonding pads 102b of substrate 101; and bonding pads 113d may be wire bond connected to corresponding bonding pads 103b of substrate 101.

FIG. 1C illustrates memory component 100 with example wire bond interconnections. In FIG. 1C, wire bonds connect individual and unique ones of CA interface bonding pads 111a with individual and unique ones of CA interface bonding pads 101a, individual and unique ones of CA interface bonding pads 111b with individual and unique ones of CA interface bonding pads 101a, individual and unique ones of CA interface bonding pads 111c with individual and unique ones of CA interface bonding pads 101c, and individual and unique ones of CA interface bonding pads 111d with individual and unique ones of CA interface bonding pads 101b. Wire bonds also connect individual and unique ones of additional interface bonding pads 113a with individual and unique ones of additional interface bonding pads 103a, individual and unique ones of additional interface bonding pads 113b with individual and unique ones of additional interface bonding pads 103a, individual and unique ones of additional interface bonding pads 113c with individual and unique ones of additional interface bonding pads 103b, and individual and unique ones of additional interface bonding pads 113d with individual and unique ones of additional interface bonding pads 103b.

Also in FIG. 1C, wire bonds connect individual and unique ones of DQ interface bonding pads 112aa with individual and unique ones of DQ interface bonding pads 102a, individual and unique ones of DQ interface bonding pads 111ba with individual and unique ones of DQ interface bonding pads 102a, individual and unique ones of DQ interface bonding pads 111cb with individual and unique ones of DQ interface bonding pads 102b, and individual and unique ones of DQ interface bonding pads 111db with individual and unique ones of DQ interface bonding pads 102b.

In another embodiment (not illustrated by example in FIG. 1C), wire bonds may connect between bonding pads of two or more of memory die 110a-110d. These connected bonding pads may then be further wire bonded to bonding pad(s) of substrate 101. For example, one or more bonding pads of CA interface bonding pads 111c may be wire bonded to corresponding bonding pads of CA interface bonding pads 111a (which then may be further wire bonded to corresponding bonding pads of CA interface 101a bonding pads). In another example, one or more bonding pads of DQ interface bonding pads 112c may be wire bonded to corresponding bonding pads of DQ interface bonding pads 112a (which then may be further wire bonded to corresponding bonding pads of DQ interface 102a bonding pads). Similarly, in yet another example, one or more bonding pads of additional interface bonding pads 113c may be wire bonded to corresponding bonding pads of additional interface bonding pads 113a (which then may be further wire bonded to corresponding bonding pads of additional interface 101a bonding pads).

In an embodiment, as illustrated in FIGS. 1A-1E, each of memory die 110a-110d includes a first set of DQ interface pads 112aa-112da (e.g., data signals, data timing signals, and/or power supply pads) and a second set of DQ interface pads 112ab-112db (e.g., the same data signals, data timing signals, and/or power supply pads). The one of the first and second sets of DQ interface pads 112aa-112db that are enabled and/or wirebond connected to substrate 101 is selected according to the rotational orientation of the respective memory die 110a-110d. Thus, memory die 110a uses DQ interface bonding pads 112aa and memory die 110b uses DQ interface bonding pads 112ba where the oppositely rotated memory die 110c-110d respectively use DQ interface bonding pads 112cb-112db. By selected the set of DQ interface bonding pads 112aa-112db based on the rotation of the respective memory die 110a-110d with respect to substrate 101, the design and pinout of memory component 100 may involve less internal routing and/or reduced signal lengths to a controller and/or other memory component interface than memory die with a single set of DQ interface bonding pads.

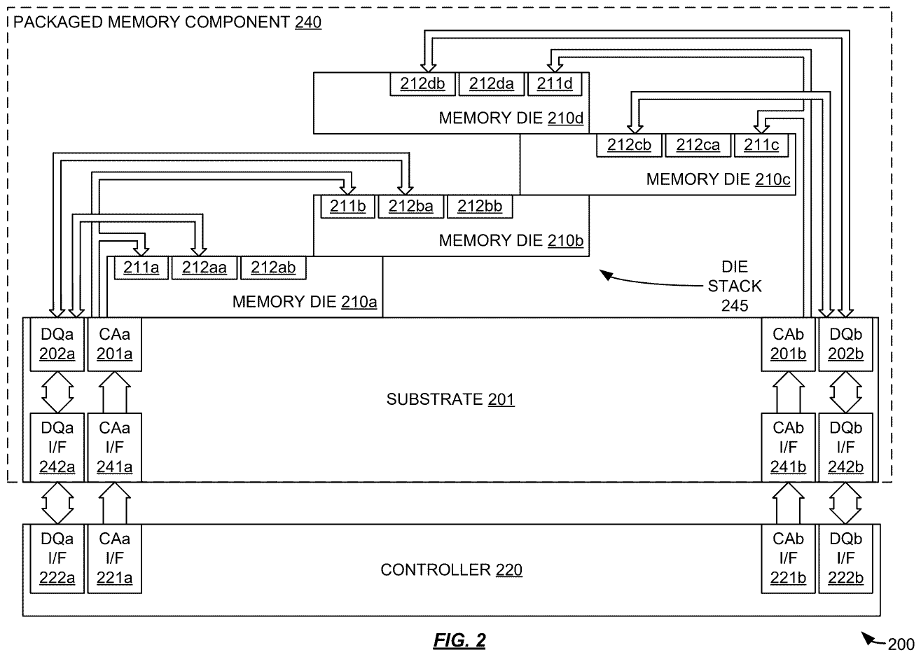

FIG. 2 is a block diagram illustrating an example stacked die memory system. In FIG. 2, memory system 200 comprises packaged memory component 240 and controller 220. Packaged memory component 240 may be or comprise an example of memory component 100. Packaged memory component 240 includes substrate 201 and die stack 245. Substrate 201 includes channel A command/address (CAa) interface 241a, channel A data (DQa) interface 242a, channel B command/address (CAb) interface 241b, channel B DQ (DQb) interface 242b, channel A (CAa) bonding pads 201a, channel A (DQa) bonding pads 202a, channel B (CAb) bonding pads 201b, and channel B (DQb) bonding pads 202b. Controller 220 comprises channel A command/address (CAa) interface 221a, channel A data (DQa) interface 222a, channel B command/address (CAb) interface 221b, channel B DQ (DQb) interface 222b.

Die stack 245 comprises stacked memory die 210a-210d. Memory die 210a-210d respectively include command/address interfaces 211a-211d, first DQ interfaces 212aa-212da, and second DQ interfaces 212ab-212db. In FIG. 2, memory die 210a is disposed on top of substrate 201. Memory die 210b is disposed on top of memory die 210a. Memory die 210c is disposed on top of memory die 210b. Memory die 210d is disposed on top of memory die 210c.

CAa interface 241a of substrate 201 (and packaged memory component 240) is operatively coupled with CAa bonding pads 201a. DQa interface 242a of substrate 201 (and packaged memory component 240) is operatively coupled with DQa bonding pads 202a. CAb interface 241b of substrate 201 (and packaged memory component 240) is operatively coupled with CAb bonding pads 201b. DQb interface 242b of substrate 201 (and packaged memory component 240) is operatively coupled with DQb bonding pads 202b.

CAa bonding pads 201a are connected with CA interface 211a of memory die 210a and CA interface 211b of memory die 210b. A first portion of DQa bonding pads 202a (e.g., DQ[0:1], DQ[0:3], DQ[0:7], etc.) are connected with DQ interface 212aa of memory die 210a. A second portion of DQa bonding pads 202a (e.g., DQ[2:3], DQ[4:7], DQ[8:15], etc.) are connected with DQa interface 212ba of memory die 210b. CAb bonding pads 201b are connected with CA interface 211c of memory die 210c and CA interface 211d of memory die 210d. A first portion of DQb bonding pads 202b (e.g., DQ[0:1], DQ[0:3], DQ[0:7], etc.) are connected with DQb interface 212cb of memory die 210c. A second portion of DQb bonding pads 202b (e.g., DQ[2:3], DQ[4:7], DQ[8:15], etc.) are connected with DQb interface 212db of memory die 210d.

CAa interface 221a of controller 220 is operatively coupled with CAa interface 241a of packaged memory component 240. Thus, controller 220 may communicate commands and addresses with CA interface 211a of memory die 210a and CA interface 211b of memory die 210b via CAa interface 221a, CAa interface 241a, and CAa bonding pads 201a. DQa interface 222a of controller 220 is operatively coupled with DQa interface 242a of packaged memory component 240. Thus, controller 220 may communicate data with DQ interface 212aa of memory die 210a via a first portion of DQa interface 222a (e.g., DQ[0:1], DQ[0:3], DQ[0:7], etc.), a corresponding first portion of DQa interface 242a, and a corresponding first portion of DQa bonding pads 202a. Likewise, controller 220 may communicate data with DQ interface 212ba of memory die 210b via a second portion of DQa interface 222a (e.g., DQ[2:3], DQ[4:7], DQ[8:15], etc.), a corresponding second portion of DQa interface 242a, and a corresponding second portion of DQa bonding pads 202a.

CAb interface 221b of controller 220 is operatively coupled with CAb interface 241b of packaged memory component 240. Thus, controller 220 may communicate commands and addresses with CA interface 211c of memory die 210c and CA interface 211d of memory die 210d via CAb interface 221b, CAb interface 241b, and CAb bonding pads 201b. DQb interface 222b of controller 220 is operatively coupled with DQb interface 242b of packaged memory component 240. Thus, controller 220 may communicate data with DQ interface 212cb of memory die 210c via a first portion of DQb interface 222b (e.g., DQ[0:1], DQ[0:3], DQ[0:7], etc.), a corresponding first portion of DQb interface 242b, and a corresponding first portion of DQb bonding pads 202b. Likewise, controller 220 may communicate data with DQ interface 212db of memory die 210d via a second portion of DQb interface 222b (e.g., DQ[2:3], DQ[4:7], DQ[8:15], etc.), a corresponding second portion of DQb interface 242b, and a corresponding second portion of DQb bonding pads 202b.

Controller 220 and memory die 210a-210d may be one or more integrated circuit type devices, such as are commonly referred to as “chips”. A memory controller, such as controller 220, manages the flow of data going to and from memory devices, and/or memory components such as memory modules and/or memory device stacks (e.g., High Bandwidth memory—HBM). Packaged memory component 240 may be a standalone device, or may be a component of a memory module such as a DIMM module used in servers. In an embodiment, memory die 210a-210d may be devices that adhere to, or are compatible with, a dynamic random access memory (DRAM) specification. In an embodiment, memory die 210a-210d may be, or comprise, a device that is or includes other memory device technologies and/or specifications. A memory controller can be a separate, standalone chip, or integrated into another chip. For example, a memory controller 220 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet die. The I/O die and CPU chiplet die may be co-packaged together and coupled to one-another via a silicon interposer.

In an embodiment, each of the sets of bonding pads of DQa interfaces 212aa-212da are located in a first respective physical location on each of memory die 210a-210d that is the same as the other sets of bonding pads of DQa interfaces 212aa-212da. Likewise, each of the sets of bonding pads of DQa interfaces 212ab-212db are located in a second respective physical location on each of memory die 210a-210d that is the same as the other sets of bonding pads of DQa interfaces 212ab-212db.

Memory die 210a and memory die 210b operate in a first mode where memory die 210a uses DQ interface 212aa and memory die 210b uses DQ interface 212ba for data communication with a first memory device access interface of packaged memory component 240 comprising CAa interface 241a and DQa interface 242a. Memory die 210c and memory die 210d operate in a second mode where memory die 210c uses DQ interface 212cb and memory die 210d uses DQ interface 212db for data communication with a second memory device access interface of packaged memory component 240 comprising CAb interface 241b and DQb interface 242b.

In an embodiment, each of memory die 210a-210d each include mode setting circuitry to determine which of the first mode and the second mode a respective memory die 210a-210d is to operate. In an embodiment, the one of the first mode and the second mode a respective memory die 210a-210d is to operate may be based on, for example, one or more commands received by the respective memory die 210a-210d (e.g., via CA 211a-211d, respectively). In an embodiment, the one of the first mode and the second mode a respective memory die 210a-210d is to operate may be based on, for example, the wiring (e.g., bonding) of a respective memory die 210a-210d with substrate 201. In an embodiment, the one of the first mode and the second mode a respective memory die 210a-210d is to operate may be based on, for example, the wiring of a respective memory die 210a-210d and/or the substrate 201 to or with the wiring of another substrate (e.g., module, printed circuit board, etc. setting a pad of a memory die 210a-210d to a positive or negative supply voltage via substrate 201). In an embodiment, the one of the first mode and the second mode a respective memory die 210a-210d is to operate may be based on, for example, a fuse or other nonvolatile memory function or circuit.

In an embodiment, the first memory device access interface of packaged memory component 240 comprising CAa interface 241a and DQa interface 242a and the second memory device access interface of packaged memory component 240 comprising CAb interface 241b and DQb interface 242b each include command, address, and data transfer functions that operate independently of the command, address, and data transfer functions of the other of the first memory device access interface and the second memory device access interface. In an embodiment, the first memory device access interface of packaged memory component 240 is on a first side of a centerline of substrate 201 and the second memory device access interface of packaged memory component 240 is on a second side of that centerline of the substrate where the first side and the second side are on opposing sides of the centerline of the substrate (e.g., left and right, top and bottom, north and south, east and west, etc.).

In an embodiment, memory die 210a and memory die 210b have a first rotational orientation with respect to substrate 201 that places a majority of the bonding pads of CA interfaces 211a-211b, DQa interfaces 212ab-212ba, and DQb interfaces 212ab-212bb on the first side of the aforementioned centerline of substrate 201. Memory die 210c and memory die 210d have a second rotational orientation (e.g., 180° relative to memory die 210a's orientation, same faces for both die upward) with respect to substrate 201 that places a majority of the bonding pads of CA interfaces 211c-211d, DQa interfaces 212ca-212da, and DQb interfaces 212cb-212db on the second side of the aforementioned centerline of substrate 201. In an embodiment, the bonding pads of DQa interfaces 212aa-212da are on a first side of a centerline of their respective memory die 210a-210d and the bonding pads of DQb interfaces 212ab-212db are on a second side of that centerline of their respective memory die 210a-210d that is opposite of the first side.

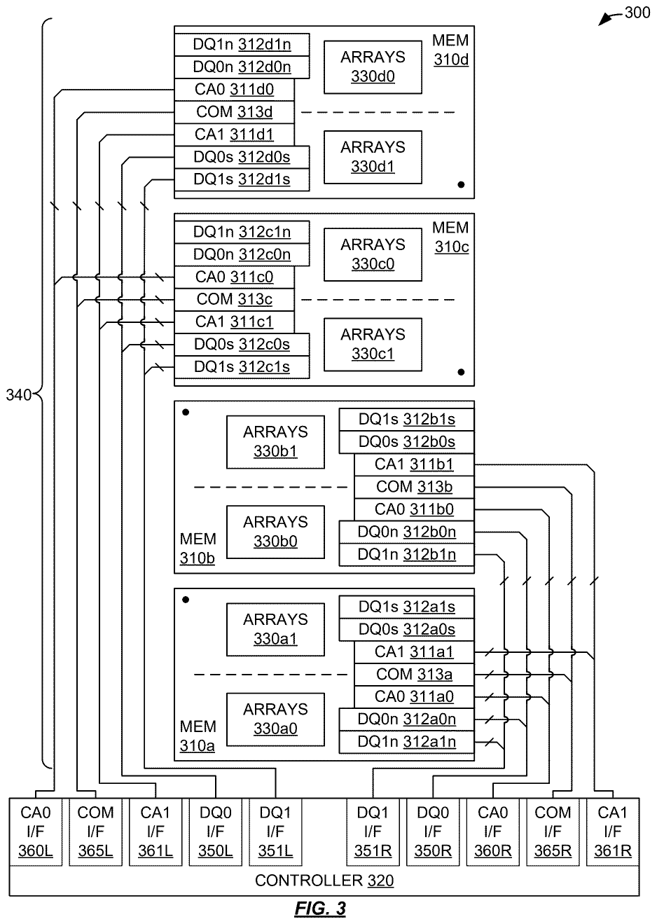

FIG. 3 is a block diagram illustrating an example symmetric I/O memory system. In FIG. 3, memory system 300 comprises controller 320 and packaged memory component 340. Packaged memory component 340 includes memory devices 310a-310d and a substrate (not shown in FIG. 3). Packaged memory component 240 may be or comprise an example of memory component 100. In an embodiment, memory device 310a is disposed on the substrate. Memory device 310b is stacked above on memory device 310a and may have the same rotational orientation as memory device 310a. Memory device 310c is stacked above memory device 310b and may be rotated 180° with respect to memory devices 310a-310b. Memory device 310d is stacked above memory device 310c and may be rotated 180° with respect to memory devices 310a-310b (i.e., have the same rotational orientation as memory device 310c).

Memory devices 310a-310d respectively include channel 0 command/address interface CA0 311a0-311d0, channel 1 command/address interface CA1 311a1-311d1, first (a.k.a., for example, top, or north) channel 0 data interface DQ0n 312a0n-312d0n, first (a.k.a., for example, top, or north) channel 1 data interface DQ1n 312a1n-312d1n, second (a.k.a., for example, bottom, or south) channel 0 data interface DQ0s 312a0s-312d0s, second (a.k.a., for example, bottom, or south) channel 1 data interface DQ1s 312a1s-312d1s, common signal interface 313a-313d, channel 0 memory arrays 330a0, and channel 1 memory arrays 330a1. In an embodiment, each of the sets of bonding pads of the first channel 0 data interfaces DQ0n 312a0n-312d0n are located in a first respective physical location on the die of each of memory devices 310a-310d that is the same as the other sets of bonding pads of the first channel 0 data interfaces DQ0n 312a0n-312d0n, and each of the sets of bonding pads of the first channel 1 data interfaces DQ1n 312a1n-312d1n are located in a second respective physical location on the die of each of memory devices 310a-310d that is the same as the other sets of bonding pads of the first channel 1 data interfaces DQ1n 312a1n-312d1n. Similarly, in an embodiment, each of the sets of bonding pads of the second channel 0 data interfaces DQ0s 312a0s-312d0s are located in a third respective physical location on the die of each of memory devices 310a-310d that is the same as the other sets of bonding pads of the second channel 0 data interfaces DQ0s 312a0s-312d0s and each of the sets of bonding pads of the second channel 1 data interfaces DQ1s 312a1s-312d1s are located in a fourth respective physical location on the die of each of memory devices 310a-310d that is the same as the other sets of bonding pads of the second channel 1 data interfaces DQ1s 312a1s-312d1s. In an embodiment, the first channel 0 data interfaces DQ0n 312a0n-312d0n are on a first side of a centerline of the dies of memory devices 310a-310d and the second channel 0 data interfaces DQ0s 312a0s-312d0s are on a second side of that centerline of the die, where the first side and the second side are on opposing sides of that centerline of the dies (e.g., left and right, top and bottom, north and south, east and west, etc.). Similarly, the first channel 1 data interfaces DQ1n 312a1n-312d1n are on the first side of that same centerline of the dies of memory devices 310a-310d and the second channel 1 data interfaces DQ1s 312a1s-312d1s are on the second side of that same centerline of the substrate.

In an embodiment, the memory channel 0 access interface of memory devices 310a-310d (each respectively comprising a CA0 interface 311a0-311d0, a common signal interface 313a-313d, and a respective one of a first channel 0 data interface DQ0n 312a0n-312d0n and a second channel 0 data interface DQ0s 312a0s-312d0s being used to access respective memory arrays 330a0-330d0) and the memory channel 1 access interface of memory devices 310a-310d (each respectively comprising a CA1 interface 311a0-311d0, a common signal interface 313as-313d, and a respective one of a first channel 1 data interface DQ1n 312a1n-312d1n and a second channel 1 data interface DQ1s 312a1s-312d1s being used to access respective memory arrays 330a1-330d1) each include command, address, and data transfer functions that operate independently of the command, address, and data transfer functions of the other memory channel 0 access interface and memory channel 1 access interface.

In an embodiment, timing signals used for communication via the data and/or command/address interfaces of memory channel 0 and memory channel 1 may be shared (e.g., be part of common signal interfaces 313a-313d). In this embodiment command, address, and data transfer functions of memory channel 0 access interface and memory channel 1 access interface may operate independently of the other memory channel access interface but with the exception of both needing to read or write data at the same time. In another embodiment, the timing signals used for communication the data and/or command/address interfaces of memory channel 0 and memory channel 1 may be part of one or more of the respective data interfaces DQ0n 312a0n-312d0n DQ0s 312a0s-312d0s DQ1n 312a1n-312d1n DQ1s 312a1s-312d1s and/or CA interfaces 311a0-311d0 311a1-311d1.

From the foregoing, it should be understood that the substrate of packaged memory component 340 includes two dual-channel external memory access interfaces. A first dual-channel external memory access interface disposed on the substrate of packaged memory component 340 is coupled with the CA0 interfaces 311a0-311b0 and data interfaces DQ0n 312a0n-312b0n to independently access memory arrays 330a0-330b0 and is coupled with the CA1 interfaces 311a1-311b1 and data interfaces DQ1n 312a1n-312b1n to independently access memory arrays 330a1-330b1. Similarly, a second dual-channel external memory access interface disposed on the substrate of packaged memory component 340 is coupled with the CA0 interfaces 311c0-311d0 and data interfaces DQ0s 312c0s-312d0s to independently access memory arrays 330c0-330d0 and is coupled with the CA1 interfaces 311c1-311d1 and data interfaces DQ1s 312c1s-312d1s to independently access memory arrays 330c1-330d1.

It should also be understood that, in an embodiment, the first rotational orientation of memory device 310a (and thus also memory device 310b) places a first majority of the active first channel 0 data interface DQ0n 312a0n and active first channel 1 data interface DQ1n 312a1n in closer physical (and/or electrical) proximity to the first dual-channel external memory access interface than the second dual-channel external memory access interface. Similarly, the second rotational orientation of memory device 310c (and thus also memory device 310d) places a second majority of the active first channel 0 data interface DQ0s 312c0s and the active first channel 1 data interface DQ1s 312c1s in closer physical (and/or electrical) proximity to the second dual-channel external memory access interface than the first dual-channel external memory access interface.

Controller 320 and memory devices 310a-310d may be one or more integrated circuit type devices, such as are commonly referred to as “chips”. A memory controller, such as controller 320, manages the flow of data going to and from memory devices, and/or memory components such as memory modules and/or memory device stacks (e.g., High Bandwidth memory—HBM). Packaged memory component 340 may be a standalone device, or may be a component of a memory module such as a DIMM module used in servers. In an embodiment, memory devices 310a-310d may be devices that adhere to, or are compatible with, a dynamic random access memory (DRAM) specification. In an embodiment, memory devices 310a-310d may be, or comprise, a device that is or includes other memory device technologies and/or specifications. A memory controller can be a separate, standalone chip, or integrated into another chip. For example, a memory controller 320 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect. In addition, memory controller functionality may be disposed on a separate Input/Output (I/O) die along with the transmitter/receiver circuits that interface to the memory device. Such an I/O die may include other types of I/O interfaces, as well as one or more chiplet interfaces that communicate with one or more respective CPU chiplet die. The I/O die and CPU chiplet die may be co-packaged together and coupled to one-another via a silicon interposer.

Controller 320 includes first (a.k.a., for example, right, or west) channel 0 command/address interface CA0 360R, first (a.k.a., for example, right, or west) channel 1 command/address interface CA1 361R, first (a.k.a., for example, right, or west) channel 0 data interface DQ0 350R, first (a.k.a., for example, right, or west) channel 1 data interface DQ0 351R, first (a.k.a., for example, right, or west) common signal interface COM 365R, second (a.k.a., for example, left, or east) channel 0 command/address interface CA0 360L, second (a.k.a., for example, left, or east) channel 1 command/address interface CA1 361L, second (a.k.a., for example, left, or east) channel 0 data interface DQ0 350L, second (a.k.a., for example, left, or east) channel 1 data interface DQ0 351L, and second (a.k.a., for example, left, or east) common signal interface COM 365L,

First channel 0 command/address interface CA0 360R of controller 320 is operatively coupled with channel 0 command/address interface CA0 311a0 of memory device 310a and channel 0 command/address interface CA0 311b0 of memory device 310b. First channel 1 command/address interface CA1 361R of controller 320 is operatively coupled with channel 1 command/address interface CA1 311a1 of memory device 310b and channel 1 command/address interface CA1 311b1 of memory device 310b. First channel 0 data interface DQ0 350R of controller 320 is operatively coupled with first channel 0 data interface DQ0n 312a0n of memory device 310a and first channel 0 data interface DQ0n 312b0n of memory device 310b. First channel 1 data interface DQ1 351R of controller 320 is operatively coupled with first channel 1 data interface DQ1n 312a1n of memory device 310a and first channel 1 data interface DQ1n 312b1n of memory device 310b. First common signal interface COM 365R is operatively coupled with common signal interface 313a of memory device 310a and common signal interface 313b of memory device 310b.

Second channel 0 command/address interface CA0 360L of controller 320 is operatively coupled with channel 0 command/address interface CA0 311c0 of memory device 310c and channel 0 command/address interface CA0 311d0 of memory device 310d. Second channel 1 command/address interface CA1 361L of controller 320 is operatively coupled with channel 1 command/address interface CA1 311c1 of memory device 310c and channel 1 command/address interface CA1 311d1 of memory device 310d. Second channel 0 data interface DQ0 350L of controller 320 is operatively coupled with second channel 0 data interface DQ0s 312c0s of memory device 310c and second channel 0 data interface DQ0s 312d0s of memory device 310d. Second channel 1 data interface DQ1 351L of controller 320 is operatively coupled with second channel 1 data interface DQ1s 312c1s of memory device 310a and second channel 1 data interface DQ1s 312d1s of memory device 310d. Second common signal interface COM 365L is operatively coupled with common signal interface 313c of memory device 310c and common signal interface 313d of memory device 310d.

Memory device 310a and memory device 310b operate in a first mode where memory device 310a uses first DQ0n interface 312a0n and memory device 310b uses first DQ0n interface 312b0n for channel 0 data communication with controller 220 (e.g., responsive to commands/addresses received via channel 0 CA0 311a0-311b0 interfaces), and memory device 310a uses first DQ1n interface 312a1n and memory device 310b uses first DQ1n interface 312b1n for channel 1 data communication with controller 220 (e.g., responsive to commands/addresses received via channel 1 CA1 311a1-311b1 interfaces). Memory device 310a and memory device 310b may operate, and/or be configured (e.g., by controller 320) to operate, in this first mode based on their rotational orientation with respect to packaged memory component 340's substrate and/or one or more of the other memory devices 310a-310d. Memory device 310c and memory device 310d operate in a second mode where memory device 310c uses second DQ0s interface 312c0s and memory device 310d uses second DQ0s interface 312c0s for channel 1 data communication with controller 220 (e.g., responsive to commands/addresses received via channel 1 CA1 311cl-311d1 interfaces), and memory device 310c uses second DQ1s interface 312c1s and memory device 310d uses second DQ1s interface 312d1s for channel 1 data communication with controller 220 (e.g., responsive to commands/addresses received via channel 1 CA1 311c1-311d1 interfaces). Memory device 310c and memory device 310d may operate, and/or be configured to operate (e.g., by controller 320), in this second mode based on their rotational orientation with respect to packaged memory component 340's substrate and/or one or more of the other memory devices 310a-310d.

In an embodiment, each of memory devices 310a-310d each include mode setting circuitry to determine which of the first mode and the second mode a respective memory device 310a-310d is to operate. In an embodiment, the one of the first mode and the second mode a respective memory device 310a-310d is to operate may be based on, for example, one or more commands received by a respective memory device 310a-310d (e.g., via respective instances of one or more of CA0 311a0-310d0 and/or CA1 311a1-310d1). In an embodiment, the one of the first mode and the second mode a respective memory device 310a-310d is to operate may be based on, for example, the wiring (e.g., bonding) of a respective memory device 310a-310d to packaged memory component 340.

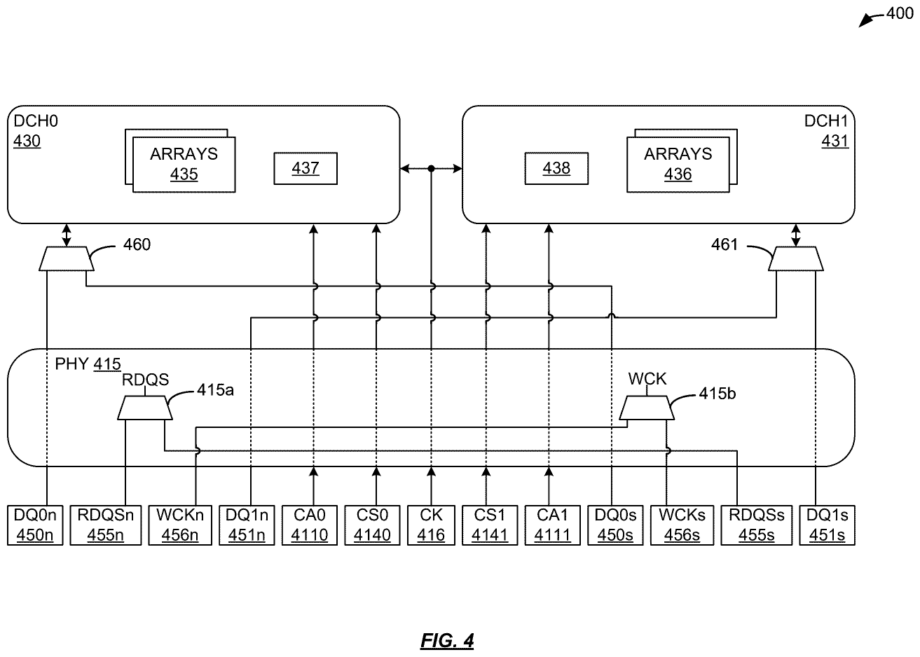

FIG. 4 is a block diagram illustrating a first example memory device. Memory device 400 may be, for example, one or more of memory die 110a-110d, memory devices 210a-210d, and memory devices 310a-310d. In FIG. 4, memory device 400 comprises physical interface circuitry (PHY) 415, channel 0 data multiplexer/demultiplexer (MUX/DMUX) circuitry 460, channel 1 data MUX/DMUX circuitry 461, die channel 0 circuitry 430, die channel 1 circuitry 431, die channel 0 command/address (CA0) pads 4110, die channel 1 command/address (CA1) pads 4111, die channel 0 chip select (CS0) pads 4140, die channel 1 chip select (CS1) pads 4141, clock signal (CK) pads 416, first channel 0 data I/O (DQ0n) pads 450n, first channel 1 data I/O (DQ1n) pads 451n, second channel 0 data I/O (DQ0s) pads 450s, second channel 1 data I/O (DQ1s) pads 451s, first read data strobe (RDQSn) pads 455n, second read data strobe (RDQSs) pads 455s, first write clock (WCKn) pads 456n, and second write clock (WCKs) pads 456s. Die channel 0 circuitry 430 comprises memory arrays 435 and mode circuitry 437. Die channel 1 circuitry 431 comprises memory arrays 436 and mode circuitry 438. Physical interface circuitry 415 comprises read data strobe DMUX 415a and write clock MUX 415b.

Clock signal pads 416 are operatively coupled with die channel 0 circuitry 430 and die channel 1 circuitry 431 via physical interface circuitry 415. CS0 pads 4140 are operatively coupled with die channel 0 circuitry 430 via physical interface circuitry 415. CS1 pads 4141 are operatively coupled with die channel 1 circuitry 431 via physical interface circuitry 415. CA0 pads 4110 are operatively coupled with die channel 0 circuitry 430 via physical interface circuitry 415. CA1 pads 4111 are operatively coupled with die channel 1 circuitry 431 via physical interface circuitry 415.

RDQSn pads 455n and RDQSs pads 455s are operatively coupled with outputs of DMUX 415a. RDQSn pads 455n and RDQSs pads 455s are operatively coupled with outputs of DMUX 415a to select a one of RDQSn pads 455n and RDQSs pads 455s to transmit read data strobe signaling (e.g., to a controller) to synchronize read data communication via one or more of DQ0n pads 450n, DQ1n pads 451n, DQ0s pads 450s, and DQ1s pads 451s. In an embodiment, one or more of mode circuitry 437 and mode circuitry 438 may determine which of RDQSn pads 455n and RDQSs pads 455s to transmit read data strobe signaling.

WCKn pads 456n and WCKs pads 456s are operatively coupled with inputs to MUX 415b. WCKn pads 456n and WCKs pads 456s are operatively coupled with inputs to MUX 415b to select a one of WCKn pads 456n and WCKs pads 456s to receive write data clock signaling (e.g., from a controller) to synchronize write data communication via one or more of DQ0n pads 450n, DQ1n pads 451n, DQ0s pads 450s, and DQ1s pads 451s. In an embodiment, one or more of mode circuitry 437 and mode circuitry 438 may determine which of WCKn pads 456n and WCKs pads 456s are to receive write data clock signaling.

MUX/DMUX circuitry 460 is operatively coupled with die channel 0 circuitry 430. MUX/DMUX circuitry 460 is also operatively coupled with DQ0n pads 450n and DQ0s pads 450s via physical interface circuitry 415. MUX/DMUX circuitry 460 is operatively coupled with die channel 0 circuitry 430, DQ0n pads 450n, and DQ0s pads 450s to select a one of DQ0n pads 450n and DQ0s pads 450s to communicate data to/from die channel 0 circuitry 430 (e.g., with a controller). In an embodiment, one or more of mode circuitry 437 and mode circuitry 438 may determine which of DQ0n pads 450n and DQ0s pads 450s are to communicate data to/from die channel 0 circuitry 430.

MUX/DMUX circuitry 461 is operatively coupled with die channel 1 circuitry 431. MUX/DMUX circuitry 461 is also operatively coupled with DQ1n pads 451n and DQ1s pads 451s via physical interface circuitry 415. MUX/DMUX circuitry 461 is operatively coupled with die channel 1 circuitry 431, DQ1n pads 451n, and DQ1s pads 451s to select a one of DQ1n pads 451n and DQ1s pads 451s to communicate data to/from die channel 0 circuitry 431 (e.g., with a controller). In an embodiment, one or more of mode circuitry 437 and mode circuitry 438 may determine which of DQ1n pads 451n and DQ1s pads 451s are to communicate data to/from die channel 1 circuitry 431.

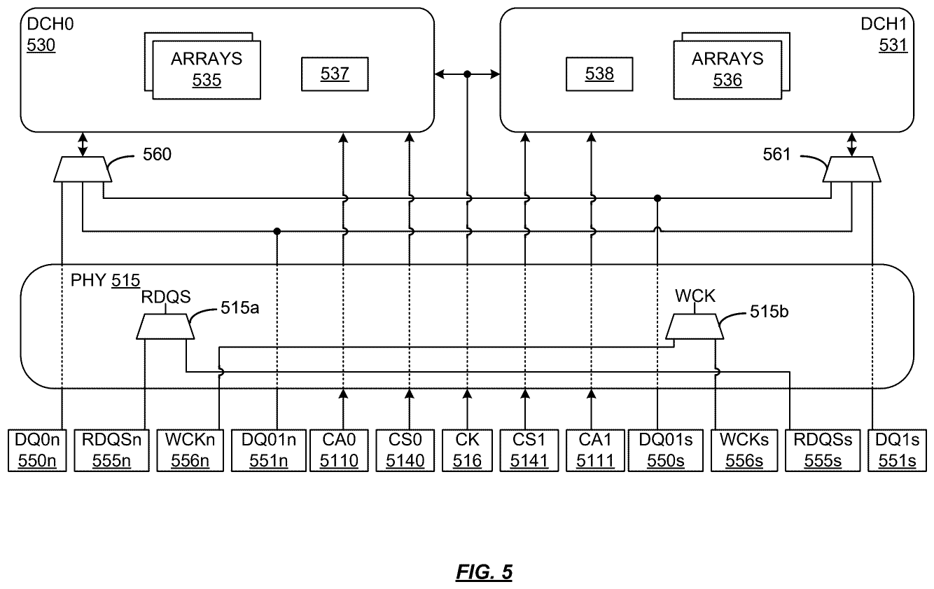

FIG. 5 is a block diagram illustrating a second example memory device. Memory device 500 may be, for example, one or more of memory die 110a-110d, memory devices 210a-210d, and memory devices 310a-310d. In FIG. 5, memory device 500 comprises physical interface circuitry (PHY) 515, channel 0 data multiplexer/demultiplexer (MUX/DMUX) circuitry 560, channel 1 data MUX/DMUX circuitry 561, die channel 0 circuitry 530, die channel 1 circuitry 531, die channel 0 command/address (CA0) pads 5110, die channel 1 command/address (CA1) pads 5111, die channel 0 chip select (CS0) pads 5140, die channel 1 chip select (CS1) pads 5141, clock signal (CK) pads 516, dedicated channel 0 data I/O (DQ0n) pads 550n, first selectable channel 0 or channel 1 data I/O (DQ01n) pads 551n, second selectable channel 0 or channel 1 data I/O (DQ01s) pads 550s, dedicated channel 1 data I/O (DQ1s) pads 551s, first read data strobe (RDQSn) pads 555n, second read data strobe (RDQSs) pads 555s, first write clock (WCKn) pads 556n, and second write clock (WCKs) pads 556s. Die channel 0 circuitry 530 comprises memory arrays 535 and mode circuitry 537. Die channel 1 circuitry 531 comprises memory arrays 536 and mode circuitry 538. Physical interface circuitry 515 comprises read data strobe DMUX 515a and write clock MUX circuitry 515b.

Clock signal pads 516 are operatively coupled with die channel 0 circuitry 530 and die channel 1 circuitry 531 via physical interface circuitry 515. CS0 pads 5140 are operatively coupled with die channel 0 circuitry 530 via physical interface circuitry 515. CS1 pads 5141 are operatively coupled with die channel 1 circuitry 531 via physical interface circuitry 515. CA0 pads 5110 are operatively coupled with die channel 0 circuitry 530 via physical interface circuitry 515. CA1 pads 5111 are operatively coupled with die channel 0 circuitry 530 via physical interface circuitry 515.

RDQSn pads 555n and RDQSs pads 555s are operatively coupled with outputs of DMUX 515a. RDQSn pads 555n and RDQSs pads 555s are operatively coupled with outputs of DMUX 515a to select a one of RDQSn pads 555n and RDQSs pads 555s to transmit read data strobe signaling (e.g., to a controller) to synchronize read data communication via one or more of DQ0n pads 550n, DQ01n pads 551n, DQ01s pads 550s, and DQ1s pads 551s. In an embodiment, one or more of mode circuitry 537 and mode circuitry 538 may determine which of RDQSn pads 555n and RDQSs pads 555s to transmit read data strobe signaling.

WCKn pads 556n and WCKs pads 556s are operatively coupled with inputs to MUX circuitry 515b. WCKn pads 556n and WCKs pads 556s are operatively coupled with inputs to MUX circuitry 515b to select a one of WCKn pads 556n and WCKs pads 556s to receive write data clock signaling (e.g., from a controller) to synchronize write data communication via one or more of DQ0n pads 550n, DQ01n pads 551n, DQ01s pads 550s, and DQ1s pads 551s. In an embodiment, one or more of mode circuitry 537 and mode circuitry 538 may determine which of WCKn pads 556n and WCKs pads 556s are to receive write data clock signaling.

MUX/DMUX circuitry 560 is operatively coupled with die channel 0 circuitry 530. MUX/DMUX circuitry 560 is also operatively coupled with DQ0n pads 550n, DQ01n pads 551n, and DQ01s pads 550s via physical interface circuitry 515. MUX/DMUX circuitry 560 is operatively coupled with die channel 0 circuitry 530, DQ0n pads 550n, DQ01n pads 551n, and DQ01s pads 550s to select one or more of DQ0n pads 550n, DQ01n pads 551n, and DQ01s pads 550s to communicate data to/from die channel 0 circuitry 530 (e.g., with a controller). In an embodiment, one or more of mode circuitry 537 and mode circuitry 538 may determine which of DQ0n pads 550n, DQ01n pads 551n, and DQ01s pads 550s are to communicate data to/from die channel 0 circuitry 530.

MUX/DMUX circuitry 561 is operatively coupled with die channel 1 circuitry 531. MUX/DMUX circuitry 561 is also operatively coupled with DQ01n pads 551n, DQ01s pads 550s, and DQ1s pads 551s via physical interface circuitry 515. MUX/DMUX circuitry 561 is operatively coupled with die channel 1 circuitry 531, DQ01n pads 551n, DQ01s pads 550s, and DQ1s pads 551s to select a one of DQ01n pads 551n, DQ01s pads 550s, and DQ1s pads 551s to communicate data to/from die channel 0 circuitry 531 (e.g., with a controller). In an embodiment, one or more of mode circuitry 537 and mode circuitry 538 may determine which of DQ01n pads 551n, DQ01s pads 550s, and DQ1s pads 551s are to communicate data to/from die channel 1 circuitry 531.

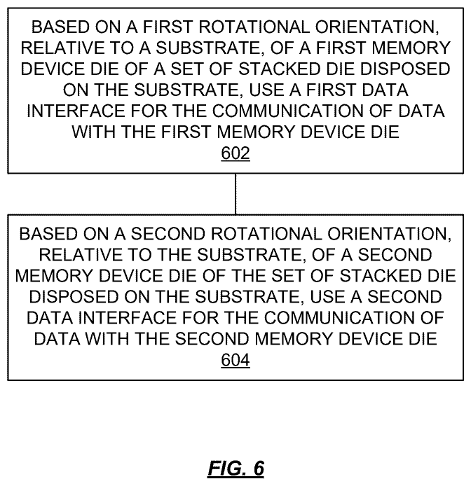

FIG. 6 is a flowchart illustrating a method of operating a memory component. One or more of the steps illustrated in FIG. 6 may be performed by, for example, component 100, system 200, system 300, memory device 400, memory device 500, and/or their components. Based on a first rotational orientation, relative to a substrate, of a first memory device die of a set of stacked die disposed on the substrate, a first data interface is used for the communication of data with the first memory device die (602). For example, based on the rotational orientation of memory die 110a relative to substrate 101, memory die 110a may use DQ interface bonding pads 112aa for communication of data and not use DQ interface bonding pads 112ab. In another example, based on the rotational orientation of memory die 210a relative to substrate 201, memory die 210a may be configured to use DQ interface 212aa for communication of data and not use DQ interface 212ab. In another example, based on the rotational orientation of memory device 310a relative to the substrate of packaged memory component 340, memory device 310a may be configured to use DQ0n interface 312a0n and DQ1n interface 312a1n for communication of data and not use DQ0s interface 312a0s and DQ1s interface 312a1s.

Based on a second rotational orientation, relative to the substrate, of a second memory device die of the set of stacked die disposed on the substrate, a second data interface is used for the communication of data with the second memory device die (604). For example, based on the rotational orientation of memory die 110c relative to substrate 101, memory die 110c may use DQ interface bonding pads 112cb for communication of data and not use DQ interface bonding pads 112ca. In another example, based on the rotational orientation of memory die 210c relative to substrate 201, memory die 210c may be configured to use DQ interface 212cb for communication of data and not use DQ interface 212ca. In another example, based on the rotational orientation of memory die 310c relative to the substrate of packaged memory component 340, memory device 310c may be configured to use DQ0s interface 312c0s and DQ1s interface 312c1s for communication of data and not use DQ0n interface 312c0n and DQ1n interface 312c1n.

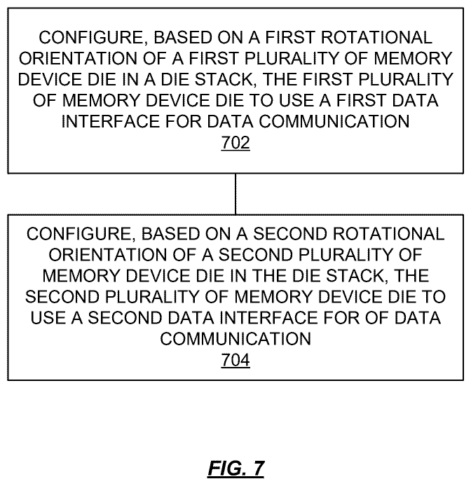

FIG. 7 is a flowchart illustrating a method of configuring a memory component.

One or more of the steps illustrated in FIG. 7 may be performed by, for example, component 100, system 200, system 300, memory device 400, memory device 500, and/or their components. Based on a first rotational orientation of a first plurality of memory device die in a die stack, the first plurality of memory device die are configured to use a first data interface for data communication (702). For example, based on the rotational orientation of memory die 110a and memory die 110b relative to substrate 101 (and/or memory die 110c-110d), memory die 110a-110b may respectively use DQ interface bonding pads 112aa-112ba for communication of data and not use DQ interface bonding pads 112ab-112bb. In another example, based on the rotational orientation of memory die 210a and memory die 210b relative to substrate 201 (and/or memory die 210c-210d), memory devices 210a-210b may be configured to respectively use DQ interface 212aa-212ba for communication of data and not use DQ interfaces 212ab-212bb. In another example, based on the rotational orientation of memory device 310a and memory device 310b relative to the substrate of packaged memory component 340 (and/or memory devices 310c-310d), memory devices 310a-310b may be configured to respectively use DQ0n interfaces 312a0n-312b0n and DQ1n interfaces 312a1n-312b1n for communication of data and not use DQ0s interfaces 312a0s-312b0s and DQ1s interfaces 312a1s-312b1s.

Based on a second rotational orientation of a second plurality of memory device die in the die stack, the second plurality of memory device die are configured to use a second data interface for data communication (704). For example, based on the rotational orientation of memory die 110c and memory die 110d relative to substrate 101 (and/or memory die 110a-110b), memory die 110c-110d may respectively use DQ interface bonding pads 112cb-112db for communication of data and not use DQ interface bonding pads 112ca-112da. In another example, based on the rotational orientation of memory die 210c and memory die 210d relative to substrate 201 (and/or memory devices 210a-210b), memory devices 210c-210d may be configured to respectively use DQ interfaces 212cd-212db for communication of data and not use DQ interfaces 212ca-212da. In another example, based on the rotational orientation of memory devices 310c relative to the substrate of packaged memory component 340 (and/or memory devices 310a-310b), memory devices 310c-310d may be configured to respectively use DQ0s interfaces 312c0s-312d0s and DQ1s interfaces 312c1s-312d1s for communication of data and not use DQ0n interfaces 312c0n-312d0n and DQ1n interfaces 312c1n-312d1n.

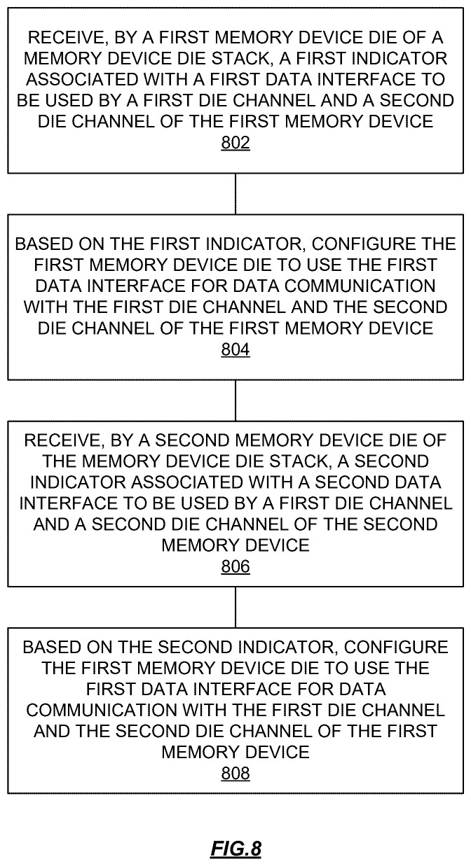

FIG. 8 is a flowchart illustrating a method of operating a stacked die memory system. One or more of the steps illustrated in FIG. 8 may be performed by, for example, component 100, system 200, system 300, memory device 400, memory device 500, and/or their components. By a first memory device die of a memory device die stack, a first indicator associated with a first data interface to be used by a first die channel and a second die channel of the first memory device is received (802). For example, memory die 310a may receive (e.g., from controller 320, or packaged memory component 340) a first indicator (e.g., mode programmed register value, programmed fuses, strapped pin, wire bonded pad, nonvolatile memory, etc.) associated with using DQ0n interface 312a0n and DQ1n interface 312a1n for communication of data and not using DQ0s interface 312a0s and DQ1s interface 312a1s. Based on the first indicator, the first memory device die is configured to use the first data interface for communication with the first die channel and the second die channel of the first memory device (804). For example, based on the first indicator, memory device 310a may be configured to use DQ0n interface 312a0n for communication with memory arrays 330a0 and to use DQ1n interface 312a1n for communication with memory arrays 330a1.

By a second memory device die of the memory device die stack, a second indicator associated with a second data interface to be used by a first die channel and a second die channel of the first memory device is received (806). For example, memory die 310c may receive (e.g., from controller 320, or packaged memory component 340) a second indicator (e.g., mode programmed register value, programmed fuses, strapped pin, wire bonded pad, nonvolatile memory, etc.) associated with using DQ0s interface 312c0s and DQ1s interface 312c1s for communication of data and not using DQ0n interface 312c0n and DQ1n interface 312c1n. Based on the second indicator, the second memory device die is configured to use the second data interface for communication with the first die channel and the second die channel of the second memory device (808). For example, based on the second indicator, memory device 310c may be configured to use DQ0s interface 312c0s for communication with memory arrays 330c0 and to use DQ1s interface 312c1s for communication with memory arrays 330c1.

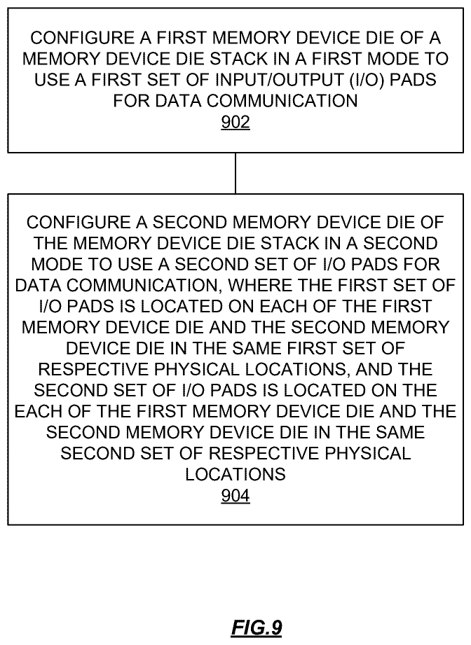

FIG. 9 is a flowchart illustrating a method of configuring the data communication of a stacked die memory component. One or more of the steps illustrated in FIG. 9 may be performed by, for example, component 100, system 200, system 300, memory device 400, memory device 500, and/or their components. A first memory device die of a memory device die stack is configured in a first mode use a first set of input/output (I/O) pads for data communication (902). For example, memory die 110a may be configured to use first DQ interface bonding pads 112aa for data communication and to disable the use of second DQ interface bonding pads 112ab. A second memory device die of the memory device die stack is configure to use a second set of I/O pads for data communication, where the first set of I/O pad is located on each of the first memory device die and the second memory device die in the same first set of respective physical locations, and the second set of I/O pads is located on the each of the first memory device die and the second memory device die in the same second set of respective physical locations (904). For example, memory die 110c may be configured to use second DQ interface bonding pads 112cb for data communication and to disable the use of second DQ interface bonding pads 112ca, where DQ interface bonding pads 112aa and DQ interface bonding pads 112ca are in the same physical locations on their respective die 110a and 110c, and DQ interface bonding pads 112ab and DQ interface bonding pads 112cb are in the same physical locations on their respective die 110a and 110.

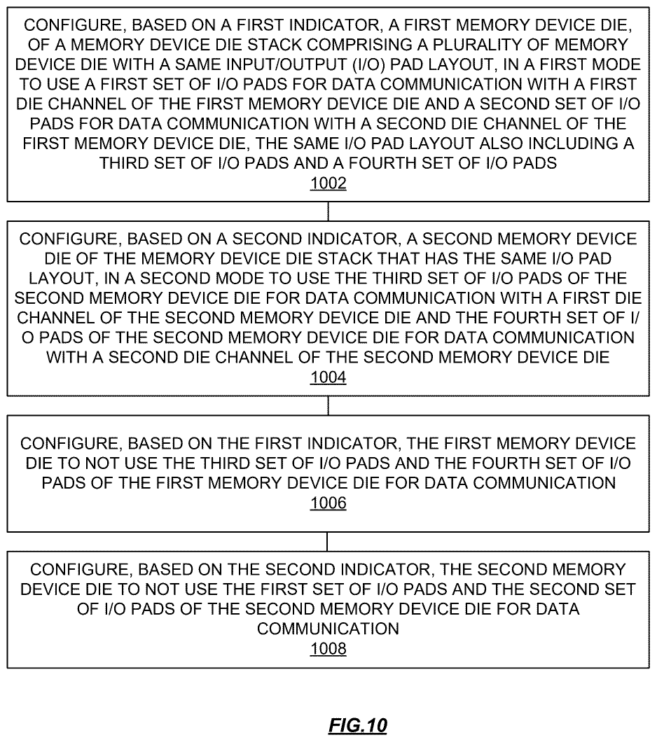

FIG. 10 is a flowchart illustrating a method of configuring multiple multi-channel die in a stacked die memory system. One or more of the steps illustrated in FIG. 10 may be performed by, for example, component 100, system 200, system 300, memory device 400, memory device 500, and/or their components. Based on a first indicator, a first memory device die, of a memory device die stack comprising a plurality of memory device die with a same input/output (I/O) pad layout, is configured in a first mode to use a first set of I/O pads for data communication with a first die channel of the first memory device die and a second set of I/O pads for data communication with a second die channel of the first memory device die, the same I/O pad layout also including a third set of I/O pads and a fourth set of I/O pads (1002). For example, memory devices 310a-310d may all have the same respective I/O pad layouts for the interfaces DQ0n, DQ1n, DQ0s, and DQ1s, where, based on a first indicator (e.g., mode programmed register value, programmed fuses, strapped pin, wire bonded pad, nonvolatile memory, etc.) memory device 310a is configured in a first mode to use DQ0n 312a0n and DQ1n 312a1n.

Based on a second indicator, a second memory device die of the memory device die stack that has the same I/O pad layout, is configured in a second mode to use the third set of I/O pads of the second memory device die for data communication with a first die channel of the second memory device die and the fourth set of I/O pads of the second memory device die for data communication with a second die channel of the second memory device die (1004). For example, based on a second indicator (e.g., mode programmed register value, programmed fuses, strapped pin, wire bonded pad, nonvolatile memory, etc.), memory device 310c may be configured in a second mode to use DQ0s 312c0s and DQ1s 312c1s, where memory devices 310a-310d all have the same respective I/O pad layouts for the interfaces DQ0n, DQ1n, DQ0s, and DQ1s.

Based on the first indicator, the first memory device die is configured to not use the third set of I/O pads and the fourth set of I/O pads of the first memory device die for data communication (1006). For example, based on the first indicator (e.g., from controller 320 and/or packed memory component 340), memory device 310a may be configured in the first mode to not use DQ0n 312a0s and DQ1n 312a1s. Based on the second indicator, the second memory device die is configured to not use the first set of I/O pads and the second set of I/O pads of the second memory device die for data communication (1008). For example, based on the second indicator (e.g., from controller 320 and/or packed memory component 340), memory device 310c may be configured in the second mode to not use DQ0n 312c0n and DQ1n 312c1n.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of component 100, system 200, system 300, memory device 400, memory device 500, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

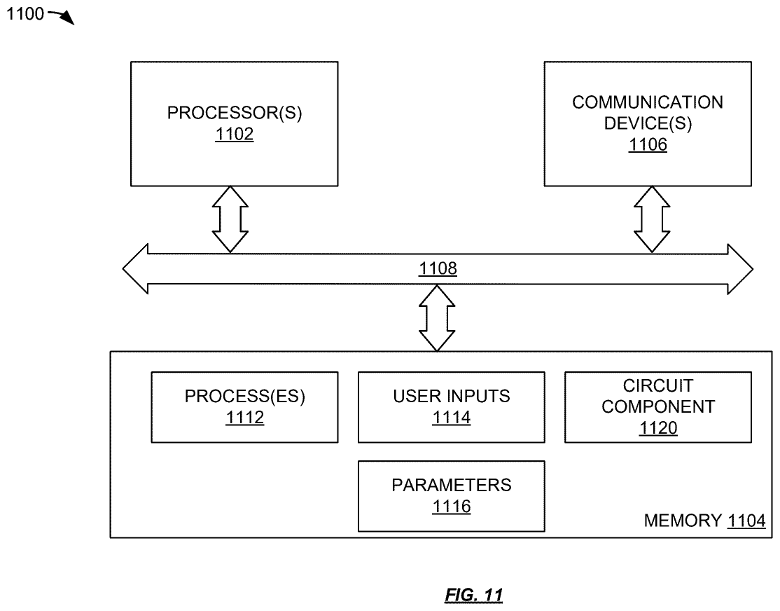

FIG. 11 is a block diagram illustrating one embodiment of a processing system 1100 for including, processing, or generating, a representation of a circuit component 1120. Processing system 1100 includes one or more processors 1102, a memory 1104, and one or more communications devices 1106. Processors 1102, memory 1104, and communications devices 1106 communicate using any suitable type, number, and/or configuration of wired and/or wireless connections 1108.

Processors 1102 execute instructions of one or more processes 1112 stored in a memory 1104 to process and/or generate circuit component 1120 responsive to user inputs 1114 and parameters 1116. Processes 1112 may be any suitable electronic design automation (EDA) tool or portion thereof used to design, simulate, analyze, and/or verify electronic circuitry and/or generate photomasks for electronic circuitry. Representation 1120 includes data that describes all or portions of component 100, system 200, system 300, memory device 400, memory device 500, and their components, as shown in the Figures.

Representation 1120 may include one or more of behavioral, register transfer, logic component, transistor, and layout geometry-level descriptions. Moreover, representation 1120 may be stored on storage media or communicated by carrier waves.

Data formats in which representation 1120 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1114 may comprise input parameters from a keyboard, mouse, voice recognition interface, microphone and speakers, graphical display, touch screen, or other type of user interface device. This user interface may be distributed among multiple interface devices. Parameters 1116 may include specifications and/or characteristics that are input to help define representation 1120. For example, parameters 1116 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1104 includes any suitable type, number, and/or configuration of non-transitory computer-readable storage media that stores processes 1112, user inputs 1114, parameters 1116, and circuit component 1120.

Communications devices 1106 include any suitable type, number, and/or configuration of wired and/or wireless devices that transmit information from processing system 1100 to another processing or storage system (not shown) and/or receive information from another processing or storage system (not shown). For example, communications devices 1106 may transmit circuit component 1120 to another system. Communications devices 1106 may receive processes 1112, user inputs 1114, parameters 1116, and/or circuit component 1120 and cause processes 1112, user inputs 1114, parameters 1116, and/or circuit component 1120 to be stored in memory 1104.

Implementations discussed herein include, but are not limited to, the following examples:
Example 1: A packaged memory component, comprising: a first dynamic random access memory (DRAM) device having a first memory access interface and a second memory access interface, the first memory access interface and the second memory access interface of the first DRAM device to operate independently of each other to access respective ones of two sets of memory cores of the first DRAM device where the two sets of memory cores of the first DRAM device are non-overlapping sets, the first memory access interface and the second memory access interface of the first DRAM device to communicate data via one of a first data interface of the first DRAM device and a second data interface of the first DRAM device; a second DRAM device having a first memory access interface and a second memory access interface, the first memory access interface and the second memory access interface of the second DRAM device to operate independently of each other to access respective ones of two sets of memory cores of the second DRAM device where the two sets of memory cores of the second DRAM device are non-overlapping sets, the first memory access interface and the second memory access interface of the second DRAM device to communicate data via one of a first data interface of the first DRAM device and a second data interface of the first DRAM device; the second DRAM device being stacked with the first DRAM device, the first DRAM device having a first rotational orientation with respect to a substrate of the packaged memory component, the second DRAM device having a second rotational orientation with respect to the substrate of the packaged memory component; the first memory access interface and the second memory access interface of the first DRAM device to, based on the first DRAM device having the first rotational orientation with respect to the substrate of the packaged memory component, communicate data via the first data interface of the first DRAM device; and the first memory access interface and the second memory access interface of the second DRAM device to, based on the second DRAM device having the second rotational orientation with respect to the substrate of the packaged memory component, communicate data via the second data interface of the second DRAM device.
Example 2: The packaged memory component of example 1, wherein: based on the first DRAM device having the first rotational orientation with respect to the substrate of the packaged memory component, the second data interface of the first DRAM device is disabled; and based on the second DRAM device having the second rotational orientation with respect to the substrate of the packaged memory component, the first data interface of the second DRAM device is disabled.
Example 3: The packaged memory component of example 1, wherein the first memory access interface and the second memory access interface of the first DRAM device are coupled with a first dual-channel external memory access interface disposed on the substrate, and the first memory access interface and second memory access interface of the second DRAM device are coupled with a second dual-channel external memory access interface disposed on the substrate.
Example 4: The packaged memory component of example 3, wherein the first dual-channel external memory access interface is on a first side of a centerline of the substrate, the second dual-channel external memory access interface is on a second side of the centerline of the substrate, where the first side and the second side are on opposing sides of the centerline of the substrate.
Example 5: The packaged memory component of example 4, wherein the first rotational orientation places a first majority of the first memory access interface and the second memory access interface of the first DRAM device closer to the first dual-channel external memory access interface than the second dual-channel external memory access interface, and the second rotational orientation places a second majority of the first memory access interface and the second memory access interface of the second DRAM device closer to the second dual-channel external memory access interface than the first dual-channel external memory access interface.
Example 6: The packaged memory component of example 1, further comprising: a third DRAM device having a first memory access interface and a second memory access interface, the first memory access interface and the second memory access interface of the third DRAM device to operate independently of each other to access respective ones of two sets of memory cores of the third DRAM device where the two sets of memory cores of the third DRAM device are non-overlapping sets, the first memory access interface and the second memory access interface of the third DRAM device to communicate data via one of a first data interface of the third DRAM device and a second data interface of the third DRAM device; a fourth DRAM device having a first memory access interface and a second memory access interface, the first memory access interface and the second memory access interface of the fourth DRAM device to operate independently of each other to access respective ones of two sets of memory cores of the fourth DRAM device where the two sets of memory cores of the fourth DRAM device are non-overlapping sets, the first memory access interface and the second memory access interface of the fourth DRAM device to communicate data via one of a first data interface of the fourth DRAM device and a second data interface of the fourth DRAM device; and the third DRAM device and the fourth DRAM device being stacked with the first DRAM device and the second DRAM device, the third DRAM device having the first rotational orientation with respect to the substrate of the packaged memory component, the fourth DRAM device having the second rotational orientation with respect to the substrate of the packaged memory component.
Example 7: The packaged memory component of example 6, wherein: the first memory access interface and the second memory access interface of the third DRAM device is to, based on the third DRAM device having the first rotational orientation with respect to the substrate of the packaged memory component, communicate data via the first data interface of the third DRAM device; and the first memory access interface and the second memory access interface of the fourth DRAM device to, based on the fourth DRAM device having the second rotational orientation with respect to the substrate of the packaged memory component, communicate data via the second data interface of the fourth DRAM device.
Example 8: A packaged memory component, comprising: a first dynamic random access memory (DRAM) die and a second DRAM die stacked with each other and each having a first set of input/output (I/O) pads and a second set of IO pads, each of the first set of IO pads of the first DRAM die and the second DRAM die located in first respective physical locations on each respective DRAM die that are the same as the other of the first set of I/O pads on the first DRAM die and the second DRAM die, each of the second set of I/O pads of the first DRAM die and the second DRAM die located in second respective physical locations on each respective DRAM die that are the same as the other of the second set of I/O pads on the first DRAM die and the second DRAM die; the first DRAM die to operate in a first mode where the first DRAM die is to use the first set of I/O pads for data communication for a first memory device access interface of the first DRAM die and a second memory device access interface of the first DRAM die, the first memory device access interface and the second memory device access interface of the first DRAM die each including command, address, and data transfer functions that operate independently of the command, address, and data transfer functions of the other of the first memory device access interface and the second memory device access interface of the first DRAM die to access respective ones of two sets of memory cores of the first DRAM die where the two sets of memory cores of the first DRAM die are non-overlapping sets; and the second DRAM die to operate in a second mode where the second DRAM die is to use the second set of I/O pads for data communication for a first memory device access interface of the second DRAM die and a second memory device access interface of the second DRAM die, the first memory device access interface and the second memory device access interface of the second DRAM die each including command, address, and data transfer functions that operate independently of the command, address, and data transfer functions of the other of the first memory device access interface and the second memory device access interface of the second DRAM die to access respective ones of two sets of memory cores of the second DRAM die where the two sets of memory cores of the second DRAM die are non-overlapping sets.
Example 9: The packaged memory component of example 8, further comprising: a substrate having a first dual-channel external interface and a second dual-channel external interface, the first memory device access interface and the second memory device access interface of the first DRAM die coupled with the first dual-channel external interface and the first memory device access interface and the second memory device access interface of the second DRAM die coupled with the second dual-channel external interface.
Example 10: The packaged memory component of example 9, wherein the first DRAM die and the second DRAM die each further comprise mode setting circuitry to determine which of the first DRAM the first mode and the second mode the first DRAM die and the second DRAM die are to respectively operate.
Example 11: The packaged memory component of example 10, wherein which of the first mode and the second mode the first DRAM die and the second DRAM die are to respectively operate is based on one or more commands received by the first DRAM die and the second DRAM die.
Example 12: The packaged memory component of example 10, wherein which of the first mode and the second mode the first DRAM die is to operate is based on a first wiring of the first DRAM die with the substrate and which of the first mode and the second mode the second DRAM die is to operate is based on a second wiring of the first DRAM die with the substrate.
Example 13: The packaged memory component of example 9, wherein the first dual-channel external interface is on a first side of a centerline of the substrate, the second dual-channel external interface is on a second side of the centerline of the substrate, where the first side and the second side are on opposing sides of the centerline of the substrate.
Example 14: The packaged memory component of example 13, wherein the first DRAM die has a first rotational orientation with respect to the substrate that places a first majority of the first memory device access interface and second memory device access interface of the first DRAM die on the first side of the centerline of the substrate, and the second DRAM die has a second rotational orientation with respect to the substrate that places a second majority of the first memory device access interface and second memory device access interface of the second DRAM die on the second side of the centerline of the substrate.
Example 15: The packaged memory component of example 14, wherein the first set of I/O pads on the first DRAM die is on a first side of a centerline of the first DRAM die, the second set of I/O pads on the first DRAM die is on a second side of the centerline of the first DRAM die, where the first side and the second side are on opposing sides of the centerline of the first DRAM die, and the first set of I/O pads on the second DRAM die is on a first side of a centerline of the second DRAM die, the second set of I/O pads on the second DRAM die is on a second side of the centerline of the second DRAM die, where the first side and the second side are on opposing sides of the centerline of the second DRAM die.
Example 16: A packaged memory component, comprising: a dynamic random access memory (DRAM) die stack comprising a first plurality of DRAM die and a second plurality of DRAM die stacked with each other and each having a first set of input/output (I/O) pads and a second set of I/O pads, each of the first set of I/O pads of the first plurality of DRAM die and the second plurality of DRAM die located in first respective physical locations on each respective DRAM die that are the same as the other of the first set of I/O pads on the first plurality of DRAM die and the second plurality of DRAM die, each of the second set of I/O pads of the first plurality of DRAM die and the second plurality of DRAM die located in second respective physical locations on each respective DRAM die that are the same as the other of the second set of I/O pads on the first plurality of DRAM die and the second plurality of DRAM die; the first plurality of DRAM die to operate in a first mode where the first plurality of DRAM die are to each use the first set of I/O pads for data communication for a first memory device access interface of each respective one of the first plurality of DRAM die and a second memory device access interface of the respective one of the first plurality of DRAM die, the first memory device access interface and the second memory device access interface of each of the first plurality of DRAM die each including command, address, and data transfer functions that operate independently of the command, address, and data transfer functions of each of the other of the first memory device access interface and the second memory device access interface, the first memory device access interface and the second memory device access interface of each of the first plurality of DRAM die to access a respective one of two sets of memory cores of the respective one of the first plurality of DRAM die where the two sets of memory cores of the respective one of the first plurality of DRAM die are non-overlapping sets; and the second plurality of DRAM die to operate in a second mode where the first plurality of DRAM die are to each use the second set of I/O pads for data communication for a first memory device access interface of each respective one of the second plurality of DRAM die and a second memory device access interface of the respective one of the second plurality of DRAM die, the first memory device access interface and the second memory device access interface of each of the second plurality of DRAM die each including command, address, and data transfer functions that operate independently of the command, address, and data transfer functions of each of the other of the first memory device access interface and the second memory device access interface, the first memory device access interface and the second memory device access interface of each of the second plurality of DRAM die to access a respective one of two sets of memory cores of the respective one of the second plurality of DRAM die where the two sets of memory cores of the respective one of the second plurality of DRAM die are non-overlapping sets.
Example 17: The packaged memory component of example 16, further comprising: a substrate with the DRAM die stack disposed thereon, the substrate having a first external memory access interface and a second external memory access interface.
Example 18: The packaged memory component of example 17, wherein the first plurality of DRAM die and the second plurality of DRAM die each have a centerline with each of the first set of I/O pads of the first plurality of DRAM die and the second plurality of DRAM die disposed on a first side of the respective centerline and each of the second set of I/O pads of the first plurality of DRAM die and the second plurality of DRAM die disposed on a second side of the respective centerline.
Example 19: The packaged memory component of example 18, wherein the first plurality of DRAM die have a first rotational orientation with respect to the substrate that places the first side of the respective centerline of each of the first plurality of DRAM die in closer proximity to the first external memory access interface than the second external memory access interface, and the second plurality of DRAM die have a second rotational orientation with respect to the substrate that places the second side of the respective centerline of each of the second plurality of DRAM die in closer proximity to the second external memory access interface than the first external memory access interface.
Example 20: The packaged memory component of example 17, wherein the first memory device access interfaces and the second memory device access interfaces of each of the first plurality of DRAM die are aggregately in closer proximity to the first external memory access interface than the second external memory access interface, and the first memory device access interfaces and the second memory device access interfaces of each of the second plurality of DRAM die are aggregately in closer proximity to the second external memory access interface than the first external memory access interface.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A packaged memory component, comprising:
a first dynamic random access memory (DRAM) device having a first memory access interface and a second memory access interface, the first memory access interface and the second memory access interface of the first DRAM device to operate independently of each other to access respective ones of two sets of memory cores of the first DRAM device where the two sets of memory cores of the first DRAM device are non-overlapping sets, the first memory access interface and the second memory access interface of the first DRAM device to communicate data via one of a first data interface of the first DRAM device and a second data interface of the first DRAM device;
a second DRAM device having a first memory access interface and a second memory access interface, the first memory access interface and the second memory access interface of the second DRAM device to operate independently of each other to access respective ones of two sets of memory cores of the second DRAM device where the two sets of memory cores of the second DRAM device are non-overlapping sets, the first memory access interface and the second memory access interface of the second DRAM device to communicate data via one of a first data interface of the first DRAM device and a second data interface of the first DRAM device;
the second DRAM device being stacked with the first DRAM device, the first DRAM device having a first rotational orientation with respect to a substrate of the packaged memory component, the second DRAM device having a second rotational orientation with respect to the substrate of the packaged memory component;
the first memory access interface and the second memory access interface of the first DRAM device to, based on the first DRAM device having the first rotational orientation with respect to the substrate of the packaged memory component, communicate data via the first data interface of the first DRAM device; and
the first memory access interface and the second memory access interface of the second DRAM device to, based on the second DRAM device having the second rotational orientation with respect to the substrate of the packaged memory component, communicate data via the second data interface of the second DRAM device.

2. The packaged memory component of claim 1, wherein:
based on the first DRAM device having the first rotational orientation with respect to the substrate of the packaged memory component, the second data interface of the first DRAM device is disabled; and
based on the second DRAM device having the second rotational orientation with respect to the substrate of the packaged memory component, the first data interface of the second DRAM device is disabled.

3. The packaged memory component of claim 1, wherein the first memory access interface and the second memory access interface of the first DRAM device are coupled with a first dual-channel external memory access interface disposed on the substrate, and the first memory access interface and second memory access interface of the second DRAM device are coupled with a second dual-channel external memory access interface disposed on the substrate.

4. The packaged memory component of claim 3, wherein the first dual-channel external memory access interface is on a first side of a centerline of the substrate, the second dual-channel external memory access interface is on a second side of the centerline of the substrate, where the first side and the second side are on opposing sides of the centerline of the substrate.

5. The packaged memory component of claim 4, wherein the first rotational orientation places a first majority of the first memory access interface and the second memory access interface of the first DRAM device closer to the first dual-channel external memory access interface than the second dual-channel external memory access interface, and the second rotational orientation places a second majority of the first memory access interface and the second memory access interface of the second DRAM device closer to the second dual-channel external memory access interface than the first dual-channel external memory access interface.

6. The packaged memory component of claim 1, further comprising:
a third DRAM device having a first memory access interface and a second memory access interface, the first memory access interface and the second memory access interface of the third DRAM device to operate independently of each other to access respective ones of two sets of memory cores of the third DRAM device where the two sets of memory cores of the third DRAM device are non-overlapping sets, the first memory access interface and the second memory access interface of the third DRAM device to communicate data via one of a first data interface of the third DRAM device and a second data interface of the third DRAM device;
a fourth DRAM device having a first memory access interface and a second memory access interface, the first memory access interface and the second memory access interface of the fourth DRAM device to operate independently of each other to access respective ones of two sets of memory cores of the fourth DRAM device where the two sets of memory cores of the fourth DRAM device are non-overlapping sets, the first memory access interface and the second memory access interface of the fourth DRAM device to communicate data via one of a first data interface of the fourth DRAM device and a second data interface of the fourth DRAM device; and
the third DRAM device and the fourth DRAM device being stacked with the first DRAM device and the second DRAM device, the third DRAM device having the first rotational orientation with respect to the substrate of the packaged memory component, the fourth DRAM device having the second rotational orientation with respect to the substrate of the packaged memory component.

7. The packaged memory component of claim 6, wherein:
the first memory access interface and the second memory access interface of the third DRAM device is to, based on the third DRAM device having the first rotational orientation with respect to the substrate of the packaged memory component, communicate data via the first data interface of the third DRAM device; and
the first memory access interface and the second memory access interface of the fourth DRAM device to, based on the fourth DRAM device having the second rotational orientation with respect to the substrate of the packaged memory component, communicate data via the second data interface of the fourth DRAM device.

8. A packaged memory component, comprising:
a first dynamic random access memory (DRAM) die and a second DRAM die stacked with each other and each having a first set of input/output (110) pads and a second set of IO pads, each of the first set of IO pads of the first DRAM die and the second DRAM die located in first respective physical locations on each respective DRAM die that are the same as the other of the first set of IO pads on the first DRAM die and the second DRAM die, each of the second set of IO pads of the first DRAM die and the second DRAM die located in second respective physical locations on each respective DRAM die that are the same as the other of the second set of IO pads on the first DRAM die and the second DRAM die;
the first DRAM die to operate in a first mode where the first DRAM die is to use the first set of I/O pads for data communication for a first memory device access interface of the first DRAM die and a second memory device access interface of the first DRAM die, the first memory device access interface and the second memory device access interface of the first DRAM die each including command, address, and data transfer functions that operate independently of the command, address, and data transfer functions of the other of the first memory device access interface and the second memory device access interface of the first DRAM die to access respective ones of two sets of memory cores of the first DRAM die where the two sets of memory cores of the first DRAM die are non-overlapping sets; and
the second DRAM die to operate in a second mode where the second DRAM die is to use the second set of I/O pads for data communication for a first memory device access interface of the second DRAM die and a second memory device access interface of the second DRAM die, the first memory device access interface and the second memory device access interface of the second DRAM die each including command, address, and data transfer functions that operate independently of the command, address, and data transfer functions of the other of the first memory device access interface and the second memory device access interface of the second DRAM die to access respective ones of two sets of memory cores of the second DRAM die where the two sets of memory cores of the second DRAM die are non-overlapping sets.

9. The packaged memory component of claim 8, further comprising:
a substrate having a first dual-channel external interface and a second dual-channel external interface, the first memory device access interface and the second memory device access interface of the first DRAM die coupled with the first dual-channel external interface and the first memory device access interface and the second memory device access interface of the second DRAM die coupled with the second dual-channel external interface.

10. The packaged memory component of claim 9, wherein the first DRAM die and the second DRAM die each further comprise mode setting circuitry to determine which of the first DRAM the first mode and the second mode the first DRAM die and the second DRAM die are to respectively operate.

11. The packaged memory component of claim 10, wherein which of the first mode and the second mode the first DRAM die and the second DRAM die are to respectively operate is based on one or more commands received by the first DRAM die and the second DRAM die.

12. The packaged memory component of claim 10, wherein which of the first mode and the second mode the first DRAM die is to operate is based on a first wiring of the first DRAM die with the substrate and which of the first mode and the second mode the second DRAM die is to operate is based on a second wiring of the first DRAM die with the substrate.

13. The packaged memory component of claim 9, wherein the first dual-channel external interface is on a first side of a centerline of the substrate, the second dual-channel external interface is on a second side of the centerline of the substrate, where the first side and the second side are on opposing sides of the centerline of the substrate.

14. The packaged memory component of claim 13, wherein the first DRAM die has a first rotational orientation with respect to the substrate that places a first majority of the first memory device access interface and second memory device access interface of the first DRAM die on the first side of the centerline of the substrate, and the second DRAM die has a second rotational orientation with respect to the substrate that places a second majority of the first memory device access interface and second memory device access interface of the second DRAM die on the second side of the centerline of the substrate.

15. The packaged memory component of claim 14, wherein the first set of I/O pads on the first DRAM die is on a first side of a centerline of the first DRAM die, the second set of I/O pads on the first DRAM die is on a second side of the centerline of the first DRAM die, where the first side and the second side are on opposing sides of the centerline of the first DRAM die, and the first set of I/O pads on the second DRAM die is on a first side of a centerline of the second DRAM die, the second set of I/O pads on the second DRAM die is on a second side of the centerline of the second DRAM die, where the first side and the second side are on opposing sides of the centerline of the second DRAM die.

16. A packaged memory component, comprising:
a dynamic random access memory (DRAM) die stack comprising a first plurality of DRAM die and a second plurality of DRAM die stacked with each other and each having a first set of input/output (I/O) pads and a second set of I/O pads, each of the first set of I/O pads of the first plurality of DRAM die and the second plurality of DRAM die located in first respective physical locations on each respective DRAM die that are the same as the other of the first set of I/O pads on the first plurality of DRAM die and the second plurality of DRAM die, each of the second set of I/O pads of the first plurality of DRAM die and the second plurality of DRAM die located in second respective physical locations on each respective DRAM die that are the same as the other of the second set of I/O pads on the first plurality of DRAM die and the second plurality of DRAM die;
the first plurality of DRAM die to operate in a first mode where the first plurality of DRAM die are to each use the first set of I/O pads for data communication for a first memory device access interface of each respective one of the first plurality of DRAM die and a second memory device access interface of the respective one of the first plurality of DRAM die, the first memory device access interface and the second memory device access interface of each of the first plurality of DRAM die each including command, address, and data transfer functions that operate independently of the command, address, and data transfer functions of each of the other of the first memory device access interface and the second memory device access interface, the first memory device access interface and the second memory device access interface of each of the first plurality of DRAM die to access a respective one of two sets of memory cores of the respective one of the first plurality of DRAM die where the two sets of memory cores of the respective one of the first plurality of DRAM die are non-overlapping sets; and
the second plurality of DRAM die to operate in a second mode where the first plurality of DRAM die are to each use the second set of I/O pads for data communication for a first memory device access interface of each respective one of the second plurality of DRAM die and a second memory device access interface of the respective one of the second plurality of DRAM die, the first memory device access interface and the second memory device access interface of each of the second plurality of DRAM die each including command, address, and data transfer functions that operate independently of the command, address, and data transfer functions of each of the other of the first memory device access interface and the second memory device access interface, the first memory device access interface and the second memory device access interface of each of the second plurality of DRAM die to access a respective one of two sets of memory cores of the respective one of the second plurality of DRAM die where the two sets of memory cores of the respective one of the second plurality of DRAM die are non-overlapping sets.

17. The packaged memory component of claim 16, further comprising:
a substrate with the DRAM die stack disposed thereon, the substrate having a first external memory access interface and a second external memory access interface.

18. The packaged memory component of claim 17, wherein the first plurality of DRAM die and the second plurality of DRAM die each have a centerline with each of the first set of I/O pads of the first plurality of DRAM die and the second plurality of DRAM die disposed on a first side of the respective centerline and each of the second set of I/O pads of the first plurality of DRAM die and the second plurality of DRAM die disposed on a second side of the respective centerline.

19. The packaged memory component of claim 18, wherein the first plurality of DRAM die have a first rotational orientation with respect to the substrate that places the first side of the respective centerline of each of the first plurality of DRAM die in closer proximity to the first external memory access interface than the second external memory access interface, and the second plurality of DRAM die have a second rotational orientation with respect to the substrate that places the second side of the respective centerline of each of the second plurality of DRAM die in closer proximity to the second external memory access interface than the first external memory access interface.

20. The packaged memory component of claim 17, wherein the first memory device access interfaces and the second memory device access interfaces of each of the first plurality of DRAM die are aggregately in closer proximity to the first external memory access interface than the second external memory access interface, and the first memory device access interfaces and the second memory device access interfaces of each of the second plurality of DRAM die are aggregately in closer proximity to the second external memory access interface than the first external memory access interface.
